(19) United States
(12) Patent Application Publication
(10) Pub. No.: US 2023/0289917 A1
(43) Pub. Date: Sep. 14, 2023

(54) MEDICAL IMAGE PROCESSING DEVICE AND MEDICAL OBSERVATION SYSTEM

(71) Applicant: Sony Olympus Medical Solutions Inc., Tokyo (JP)

(72) Inventor: Yusuke TAKENOUCHI, Tokyo (JP)

(73) Assignee: Sony Olympus Medical Solutions Inc., Tokyo (JP)

(21) Appl. No.: 18/175,567

(22) Filed: Feb. 28, 2023

(30) Foreign Application Priority Data
Mar. 8, 2022 (JP) 2022-035565

(51) Int. Cl. G06T 1/60

(52) U.S. Cl. CPC G06T 1/60; G06T 2207/30004; G06T 2207/10068; H04N 23/555

(57) ABSTRACT

A medical image processing device includes: a nonvolatile memory storing an image processing parameter; an image processing module configured to read out the image processing parameter from the nonvolatile memory, and execute image processing, by using the image processing parameter, on a captured image obtained by capturing a subject image; and a control unit configured to control an operation of the image processing module.

### CROSS-REFERENCE TO RELATED APPLICATION

This application claims priority from Japanese Application No. 2022-035565, filed on Mar. 8, 2022, the contents of which are incorporated by reference herein in its entirety.

### BACKGROUND

The present disclosure relates to a medical image processing device and a medical observation system.

In the medical field, there has been known a medical observation system that observes the inside of a subject (inside of a living body) (refer to JP 2008-149027 A, for example).

The medical observation system described in JP 2008-149027 A includes a medical observation device that images the inside of a living body to generate a captured image, and a medical image processing device including a plurality of image processing modules that individually executes image processing on the captured image, and a central processing unit (CPU) that controls the plurality of image processing modules.

Here, in the medical image processing device, when the power is turned on, the CPU reads out the image processing parameter from the memory and writes the read image processing parameter in a register provided for each image processing module. Using the image processing parameter written in the register, the image processing module executes image processing on the captured image.

### SUMMARY

The image processing parameter is a large-capacity parameter such as a lookup table. Therefore, with a configuration in which the CPU sets the large-capacity image processing parameter in the register for each image processing module as in the technology described in JP 2008-149027 A, the load on the CPU increases, taking a lot of time for the setting of the image processing parameter. This makes it incapable of quickly generating a captured image suitable for observation after image processing, making it difficult to improve convenience.

According to one aspect of the present disclosure, there is provided a medical image processing device including: a nonvolatile memory storing an image processing parameter; an image processing module configured to read out the image processing parameter from the nonvolatile memory, and execute image processing, by using the image processing parameter, on a captured image obtained by capturing a subject image; and a control unit configured to control an operation of the image processing module.

### BRIEF DESCRIPTION OF THE DRAWINGS

FIG. 1 is a diagram illustrating a configuration of a medical observation system according to a first embodiment;

FIG. 2 is a block diagram illustrating a configuration of a camera head and a control device; and

FIG. 3 is a block diagram illustrating a configuration of a camera head and a control device according to a second embodiment.

### DETAILED DESCRIPTION

Hereinafter, modes for carrying out the present disclosure (hereinafter referred to as embodiments) will be described with reference to the drawings. Note that the present disclosure is not limited to the embodiments described below. In the drawings, same reference signs are attached to the same components.

### First Embodiment

Schematic Configuration of Medical Observation System

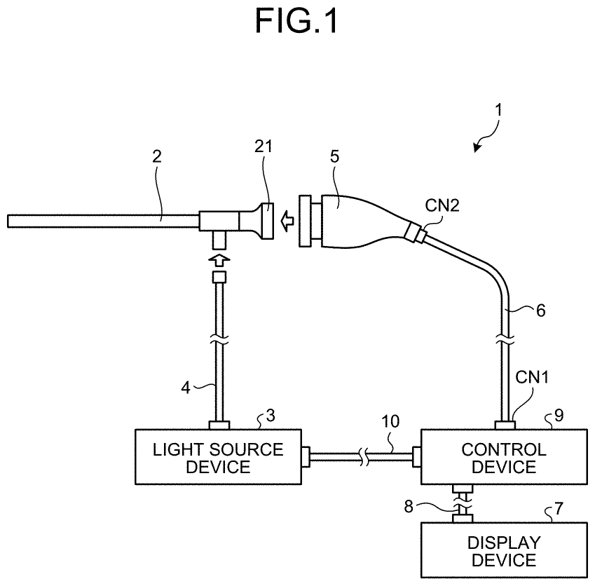

FIG. 1 is a diagram illustrating a configuration of a medical observation system 1 according to a first embodiment.

The medical observation system 1 is a system that is used in the medical field and observes the inside of a subject (living body). As illustrated in FIG. 1, the medical observation system 1 includes an insertion unit 2, a light source device 3, a light guide 4, a camera head 5, a first transmission cable 6, a display device 7, a second transmission cable 8, a control device 9, and a third transmission cable 10.

In the first embodiment, the insertion unit 2 is implemented by a rigid endoscope. That is, the insertion unit 2 has an elongated shape that is entirely rigid, or partially rigid with a partially flexible portion, so as to be inserted into a living body. The insertion unit 2 includes an optical system (not illustrated) having one or more lenses and configured to collect light (subject image) from the living body.

The light source device 3 is connected to one end of the light guide 4, and supplies illumination light of a light amount designated by the control device 9 to the one end of the light guide 4 under the control of the control device 9. In the first embodiment, the light source device 3 is separated from the control device 9. However, the configuration is not limited to this, and it is allowable to employ a configuration in which the light source device 3 is provided inside the control device 9.

The light guide 4 has one end detachably connected to the light source device 3 and the other end detachably connected to the insertion unit 2. The light guide 4 transmits the light supplied from the light source device 3 from one end to the other end and supplies the light to the insertion unit 2. The light supplied to the insertion unit 2 is emitted from a distal end of the insertion unit 2 and directed into the living body. The light (subject image) applied to internal portions of the living body is condensed by the optical system in the insertion unit 2.

The camera head 5 corresponds to a medical observation device according to the present disclosure. The camera head 5 is detachably connected to an eyepiece 21 of the insertion unit 2. In addition, the camera head 5 captures a subject image condensed by the insertion unit 2 and generates an image signal (hereinafter, referred to as a captured image) under the control of the control device 9.

Note that a detailed configuration of the camera head will be described in “Configuration of camera head” described below.

The first transmission cable 6 has one end detachably connected to the control device 9 via a connector CN1 (FIG. 1), and has the other end detachably connected to the camera head 5 via a connector CN2 (FIG. 1). The first transmission cable 6 transmits the captured image or the like output from the camera head 5 to the control device 9, and transmits a control signal, a synchronization signal, a clock, power, or the like output from the control device 9 to the camera head 5 individually.

Note that the captured image or the like transmitted from the camera head 5 to the control device 9 via the first transmission cable 6 may be transmitted in an optical signal or in an electrical signal. The similar applies to transmission of the control signal, the synchronization signal, and the clock from the control device 9 to the camera head 5 via the first transmission cable 6.

The display device 7 is implemented by a display using liquid crystal, organic Electro Luminescence (EL), or the like, and displays an image based on a video signal from the control device 9 under the control of the control device 9.

The second transmission cable 8 has one end detachably connected to the display device 7 and the other end detachably connected to the control device 9. The second transmission cable 8 transmits the video signal processed by the control device 9 to the display device 7.

The control device 9 is implemented by a central processing unit (CPU), a Field-Programmable Gate Array (FPGA), or the like, and comprehensively controls operation of the light source device 3, the camera head 5, and the display device 7.

A detailed configuration of the control device 9 will be described in “Configuration of control device” described below.

The third transmission cable 10 has one end detachably connected to the light source device 3 and the other end detachably connected to the control device 9. The third transmission cable 10 transmits the control signal from the control device 9 to the light source device 3.

Configuration of Camera Head

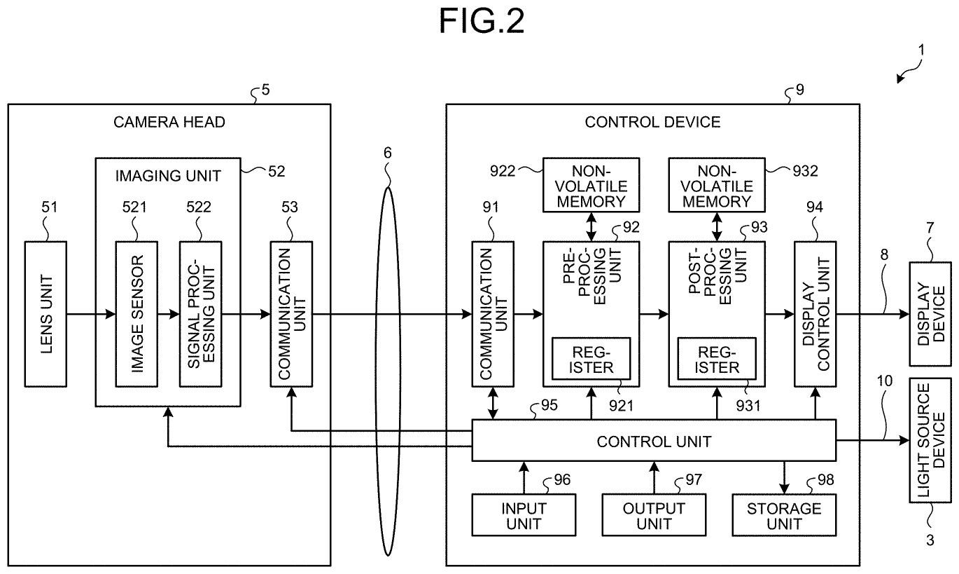

FIG. 2 is a block diagram illustrating a configuration of the camera head 5 and the control device 9.

Next, a configuration of the camera head 5 will be described with reference to FIG. 2.

As illustrated in FIG. 2, the camera head 5 includes a lens unit 51, an imaging unit 52, and a communication unit 53.

The lens unit 51 includes one or more lenses, and forms a subject image condensed by the insertion unit 2 on an imaging surface of the imaging unit 52 (an image sensor 521).

The imaging unit 52 captures the inside of the living body under the control of the control device 9. As illustrated in FIG. 2, the imaging unit 52 includes the image sensor 521 and a signal processing unit 522.

The image sensor 521 is implemented by a Charge Coupled Device (CCD), Complementary Metal Oxide Semiconductor (CMOS) or the like that receives the subject image formed by the lens unit 51 and converts the image into an electrical signal (analog signal).

The signal processing unit 522 performs signal processing on a captured image of an analog signal generated by the image sensor 521 and outputs a captured image of a digital signal.

The communication unit 53 is an interface that communicates with the control device 9 via a first transmission cable 6. The communication unit 53 transmits a captured image (digital signal) output from the imaging unit 52 to the control device 9, and receives a control signal and the like from the control device 9.

Configuration of Control Device

Next, the configuration of the control device 9 will be described with reference to FIG. 2.

The control device 9 corresponds to a medical image processing device according to the present disclosure that processes a captured image (digital signal) output from the camera head 5. As illustrated in FIG. 2, the control device 9 includes a communication unit 91, a pre-processing unit 92, a post-processing unit 93, a display control unit 94, a control unit 95, an input unit 96, an output unit 97, and a storage unit 98.

The communication unit 91 is an interface that communicates with the camera head 5 (communication unit 53) via the first transmission cable 6. The communication unit 91 receives the captured image (digital signal) output from the communication unit 53, and transmits a control signal and the like from the control unit 95.

The pre-processing unit 92 and the post-processing unit 93 each correspond to an image processing modules according to the present disclosure, and under the control of the control unit 95, execute image processing on the captured image (digital signal) output from the camera head 5 and received by the communication unit 91.

Specific examples of the image processing include optical black subtraction processing, demosaic processing, white balance adjustment processing, noise reduction processing, color correction processing, color enhancement processing, and contour enhancement processing.

In the first embodiment, the pre-processing unit 92 includes an FPGA and executes a part of the image processing described above on the captured image (digital signal) output from the camera head 5. Specifically, the pre-processing unit 92 is a logic circuit constructed by configuration data stored in nonvolatile memory 922 when the power is turned on, and includes a register 921. The pre-processing unit 92 reads out an image processing parameter from the nonvolatile memory 922, sets the image processing parameter in the register 921, and executes a part of the image processing described above using the image processing parameter.

That is, the nonvolatile memory 922 stores configuration data of the pre-processing unit 92 and image processing parameters such as a lookup table used for image processing to be executed by the pre-processing unit 92.

In the first embodiment, the post-processing unit 93 includes an FPGA, and executes image processing other than the image processing executed by the pre-processing unit 92 (hereinafter, referred to as another (other) image processing) among the above-described image processing, on the captured image (digital signal) output from the pre-processing unit 92. Specifically, the post-processing unit 93 is a logic circuit constructed by configuration data stored in nonvolatile memory 932 when power is turned on, and includes register 931. The post-processing unit 93 reads out the image processing parameter from the nonvolatile memory 932, sets the image processing parameter in the register 931, and executes the other image processing described above using the image processing parameter.

That is, the nonvolatile memory 932 stores configuration data of the post-processing unit 93 and image processing parameters such as a lookup table used for image processing executed by the post-processing unit 93.

The display control unit 94 generates a display video signal for displaying a captured image after other image processing is executed by the post-processing unit 93. Subsequently, the display control unit 94 outputs the video signal to the display device 7. With this operation, the captured image is displayed on the display device 7.

The control unit 95 is implemented by executing various programs stored in the storage unit 98 by a controller such as a CPU or a micro processing unit (MPU). The control unit 95 controls the operations of the light source device 3, the camera head 5, and the display device 7 and controls the entire operation of the control device 9. The control unit 95 may be constituted with an integrated circuit such as an application specific integrated circuit (ASIC) or an FPGA, not limited to the CPU or the MPU.

The input unit 96 is constituted with an operation device such as a mouse, a keyboard, and a touch panel, and receives user operations performed by a user such as a doctor. Subsequently, the input unit 96 outputs an operation signal corresponding to the user operation to the control unit 95.

The output unit 97 is constituted with a speaker, a printer, or the like, and outputs various types of information.

The storage unit 98 stores a program executed by the control unit 95, information needed for processing performed by the control unit 95, or the like.

Operation of Control Device

Next, operation of the above-described control device 9 will be described.

Hereinafter, for convenience of description, the operation of the control device 9 when the power is turned on will be mainly described.

When the control device 9 is powered on, the pre-processing unit 92 reads out configuration data from the nonvolatile memory 922 and constructs a desired logic circuit. In addition, the pre-processing unit 92 spontaneously reads out the image processing parameter from the nonvolatile memory 922 so as to be set in the register 921. With this operation, the pre-processing unit 92 can execute a part of the image processing described above on the captured image (digital signal) output from the camera head 5 using the image processing parameter.

Similarly, the post-processing unit 93 reads out configuration data from the nonvolatile memory 932 to construct a desired logic circuit. Further, the post-processing unit 93 spontaneously reads out the image processing parameter from the nonvolatile memory 932 so as to be set in the register 931. With this operation, the post-processing unit 93 can perform the above-described other image processing using the image processing parameter on the captured image (digital signal) output from the pre-processing unit 92.

According to the first embodiment described above, the following effects are obtained.

The control device 9 according to the first embodiment includes: the nonvolatile memory 922 (932) that stores image processing parameters; and the pre-processing unit 92 (post-processing unit 93) that reads out the image processing parameters from the nonvolatile memory 922 (932) and executes image processing on a captured image by using the image processing parameters. That is, when the power is turned on, the pre-processing unit 92 (the post-processing unit 93) spontaneously reads out the image processing parameter from the nonvolatile memory 922 (932) without waiting for the control by the control unit 95. Therefore, it is possible to achieve reduction of load on the control unit 95 in setting the image processing parameters, with great reduction of the time required for the setting.

Accordingly, with the control device 9 according to the first embodiment, it is possible to quickly generate a captured image suitable for observation after image processing and improve convenience.

In particular, the pre-processing unit 92 (post-processing unit 93) includes an FPGA. In addition, the nonvolatile memory 922 (932) stores image processing parameters and configuration data of the pre-processing unit 92 (post-processing unit 93).

This makes it possible to eliminate a need to separately provide a nonvolatile memory for the image processing parameters, leading to a simplified configuration of the control device 9.

### Second Embodiment

Next, a second embodiment will be described.

In the following, identical reference numerals are given to the components similar to those in the first embodiment described above, and detailed description thereof will be omitted or simplified.

Unlike the medical observation system 1 according to the first embodiment described above, the medical observation system 1 according to the second embodiment is configured to be capable of executing a plurality of types of operation modes. Here, examples of the operation mode include a normal observation mode in which imaging is performed with normal light such as white light, an observation mode in which observation is performed with special light, or an observation mode in which observation is performed using an image enhancement observation technology such as narrow band imaging (NBI). Examples of the special light include light in a near-infrared wavelength band and light for fluorescence observation using 5-aminolevulinic acid (5-ALA).

The user such as a doctor can select one of the plurality of types of operation modes described above in accordance with the operation on the input unit 96.

The nonvolatile memory 922 stores a plurality of types of image processing parameters corresponding to the plurality of types of operation modes described above. Similarly, the nonvolatile memory 932 stores a plurality of types of image processing parameters according to the plurality of types of operation modes.

Here, when a specific operation mode is selected according to an operation on the input unit 96 by the user such as a doctor, the control unit 95 outputs a control signal to the pre-processing unit 92 and the post-processing unit 93 individually so as to read out an image processing parameter corresponding to the selected operation mode.

Subsequently, based on the control signal from the control unit 95, the pre-processing unit 92 reads out, from the nonvolatile memory 922, the image processing parameter corresponding to the operation mode selected according to the operation on the input unit 96 by the user such as a doctor, and sets the image processing parameter in the register 921. With this operation, the pre-processing unit 92 can execute a part of the image processing described in the first embodiment described above on the captured image (digital signal) output from the camera head 5 using the image processing parameter corresponding to the selected operation mode.

Similarly, based on a control signal from the control unit 95, the post-processing unit 93 reads out, from the nonvolatile memory 932, the image processing parameter corresponding to the operation mode selected according to the operation on the input unit 96 by the user such as a doctor, and sets the image processing parameter in the register 931. With this operation, the post-processing unit 93 can execute other image processing described in the above-described first embodiment on the captured image (digital signal) output from the pre-processing unit 92 using the image processing parameter corresponding to the selected operation mode.

According to the second embodiment described above, the following effects are obtained in addition to the effects similar to the case of the first embodiment described above.

In the control device 9 according to the second embodiment, the nonvolatile memory 922 (932) stores a plurality of types of image processing parameters according to a plurality of types of operation modes of the control device 9. When a specific operation mode is selected according to the operation on the input unit 96 by the user such as a doctor, the pre-processing unit 92 (the post-processing unit 93) reads out the image processing parameter corresponding to the operation mode from the nonvolatile memory 922 (932), and executes image processing on the captured image using the image processing parameter. That is, even when the operation mode is switched in addition to when the power is turned on, the pre-processing unit 92 (post-processing unit 93) spontaneously reads out the image processing parameter from the nonvolatile memory 922 (932) without waiting for the control by the control unit 95. Therefore, even when the operation mode is switched in addition to when the power is turned on, it is possible to achieve reduction of load on the control unit 95 in setting the image processing parameters, with great reduction of the time required for the setting.

Although the pre-processing unit 92 in the above-described second embodiment reads out, from the nonvolatile memory 922, the image processing parameter corresponding to the operation mode selected according to the operation on the input unit 96 by the user such as a doctor, and sets the image processing parameter in the register 921 based on the control signal from the control unit 95, the configuration is not limited to this.

For example, the nonvolatile memory 922 stores a plurality of types of image processing parameters each associated with a plurality of types of operation modes. The pre-processing unit 92 recognizes an operation mode selected according to an operation on the input unit 96 by a user such as a doctor, reads out the image processing parameter associated with the operation mode from the nonvolatile memory 922 so as to be set in the register 921. The post-processing unit 93 may be similarly configured.

### Third Embodiment

Next, a third embodiment will be described.

In the following, identical reference numerals are given to the components similar to those in the first embodiment described above, and detailed description thereof will be omitted or simplified.

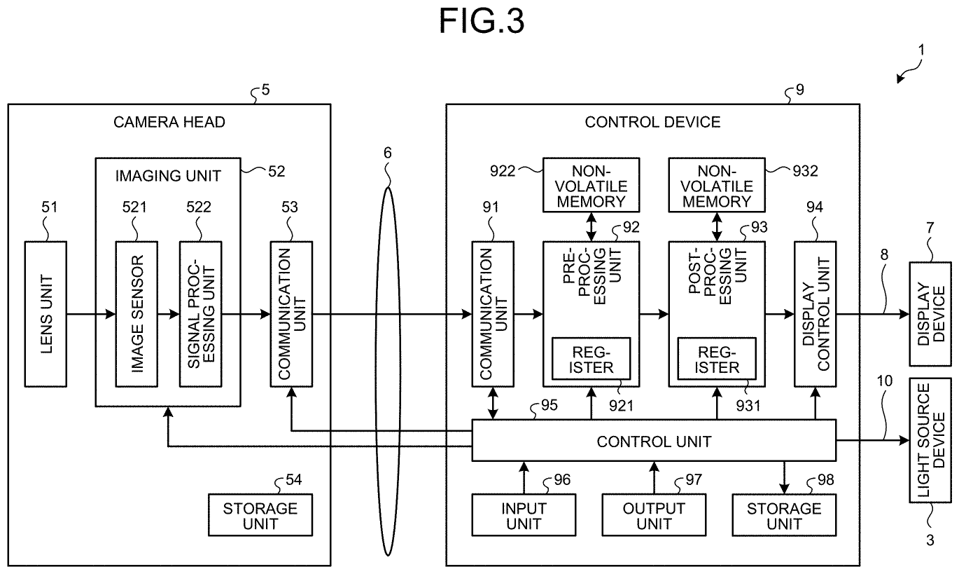

FIG. 3 is a block diagram illustrating a configuration of a camera head 5 and a control device 9 according to a third embodiment.

In the medical observation system 1 according to the second embodiment, a storage unit 54 is added to the camera head 5 unlike the camera head 5 according to the first embodiment described above.

The storage unit 54 stores a camera head identifier (ID) which is identification information for uniquely identifying the type of the camera head 5. When the camera head 5 is connected to the control device 9, the communication unit 53 transmits the camera head ID to the control device 9 (communication unit 91) via the first transmission cable 6.

In addition, the nonvolatile memory 922 according to the second embodiment stores a plurality of types of image processing parameters individually in association with each camera head ID of a plurality of types of camera heads 5. Similarly, the nonvolatile memory 932 stores a plurality of types of image processing parameters individually associated with each camera head ID of the plurality of types of camera heads 5.

Here, when having detected the camera head ID transmitted from the camera head 5 (communication unit 53) via the communication unit 91, the control unit 95 outputs the camera head ID to the pre-processing unit 92 and the post-processing unit 93 individually.

Subsequently, the pre-processing unit 92 reads out the image processing parameter associated with the camera head ID output from the control unit 95 from the nonvolatile memory 922 so as to be set in the register 921. With this operation, the pre-processing unit 92 can execute a part of the image processing described in the first embodiment above on the captured image (digital signal) output from the camera head 5 using the image processing parameter corresponding to the camera head 5.

Similarly, the post-processing unit 93 reads out the image processing parameter associated with the camera head ID output from the control unit 95 from the nonvolatile memory 932 so as to be set in the register 931. With this operation, the post-processing unit 93 can execute other image processing described in the above first embodiment on the captured image (digital signal) output from the camera head 5 using the image processing parameter corresponding to the camera head 5.

According to the third embodiment described above, the following effects are obtained in addition to the effects similar to the case of the first embodiment described above.

In the control device 9 according to the third embodiment, the nonvolatile memory 922 (932) stores a plurality of types of image processing parameters corresponding to a plurality of types of camera heads 5. The pre-processing unit 92 (post-processing unit 93) reads out the image processing parameter corresponding to the camera head 5 connected to the control device 9 from the nonvolatile memory 922 (932), and executes image processing on the captured image using the image processing parameter.

This makes it possible to execute appropriate image processing corresponding to the camera head 5 connected to the control device 9.

Although the third embodiment described above has a configuration in which the pre-processing unit 92 reads out the image processing parameter associated with the camera head ID output from the control unit 95 from the nonvolatile memory 922 so as to be set in the register 921, the configuration is not limited thereto.

For example, the nonvolatile memory 922 stores a plurality of types of image processing parameters corresponding to a plurality of types of camera head IDs. Here, when having detected the camera head ID transmitted from the camera head 5 (communication unit 53) via the communication unit 91, the control unit 95 outputs a control signal to the pre-processing unit 92 so as to read out an image processing parameter corresponding to the detected camera head ID. Subsequently, the pre-processing unit 92 reads out the image processing parameter corresponding to the camera head ID from the nonvolatile memory 922 based on the control signal from the control unit 95 so as to be set in the register 921. The post-processing unit 93 may be similarly configured.

### OTHER EMBODIMENTS

Embodiments of the present disclosure have been described hereinabove, however, the present disclosure is not intended to be limited to the above-described first to third embodiments.

In the above-described first to third embodiments, the medical image processing device according to the present disclosure is mounted on the medical observation system 1 having the insertion unit 2 formed with a rigid endoscope, but the configuration is not limited thereto. For example, the medical image processing device according to the present disclosure may be mounted on a medical observation system having the insertion unit 2 formed with a flexible endoscope. In addition, the medical image processing device according to the present disclosure may be mounted on a medical observation system such as a surgical microscope (refer to JP 2016-42981 A, for example) that enlarges and observes a predetermined field of view inside a living body or on a surface of a living body.

In the above-described first to third embodiments, the pre-processing unit 92 and the post-processing unit 93 are adopted as the image processing modules according to the present disclosure. However, the number of the image processing modules is not limited to two, and may be one, or may be three or more.

In the above-described first to third embodiments, an FPGA is adopted as the image processing module according to the present disclosure. However, but the present disclosure is not limited thereto, and for example, a complex programmable logic device (CPLD) or the like which is another type of programmable logic device may be adopted. Furthermore, the image processing module according to the present disclosure is not limited to a programmable logic device, and an ASIC or the like may be adopted.

The following configurations also belong to the technical scope of the present disclosure.
(1) A medical image processing device including: a nonvolatile memory storing an image processing parameter;
an image processing module configured to read out the image processing parameter from the nonvolatile memory, and execute image processing, by using the image processing parameter, on a captured image obtained by capturing a subject image; and a control unit configured to control an operation of the image processing module.
(2) The medical image processing device according to (1), wherein the image processing module is a programmable logic device.
(3) The medical image processing device according to (2), wherein the nonvolatile memory is configured to store the image processing parameter and configuration data for the image processing module.
(4) The medical image processing device according to any one of (1) to (3), wherein a set of the nonvolatile memory and the image processing module are provided in plurality.
(5) The medical image processing device according to any one of (1) to (4), wherein the nonvolatile memory is configured to store a plurality of types of the image processing parameters corresponding to a plurality of types of operation modes in the medical image processing device, and the image processing module is configured to read out the image processing parameter corresponding to the operation mode of the medical image processing device from the nonvolatile memory, and execute image processing on the captured image using the image processing parameter.
(6) The medical image processing device according to any one of (1) to (5), wherein the nonvolatile memory is configured to store a plurality of types of the image processing parameters corresponding to a plurality of types of medical observation devices, each of the medical observation devices being co figured to capture a subject image and generate the captured image, and the image processing module is configured to read out the image processing parameter corresponding to the medical observation device connected to the medical image processing device from the nonvolatile memory, and execute image processing on the captured image using the image processing parameter.
(7) The medical image processing device according to any one of (1) to (6), wherein the image processing module is configured to spontaneously read out the image processing parameter from the nonvolatile memory after power is turned on.
(8) A medical observation system including: a medical observation device configured to capture a subject image to generate a captured image; and a medical image processing device configured to execute image processing on the captured image, wherein the medical image processing device includes: a nonvolatile memory configured to store an image processing parameter; an image processing module configured to read out the image processing parameter from the nonvolatile memory, and execute image processing on the captured image by using the image processing parameter; and a control unit configured to control an operation of the image processing module.

With a medical image processing device and a medical observation system according to the present disclosure, it is possible to quickly generate a captured image suitable for observation after image processing and improve convenience.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A medical image processing device comprising:
a nonvolatile memory storing an image processing parameter;
an image processing module configured to
read out the image processing parameter from the nonvolatile memory, and
execute image processing, by using the image processing parameter, on a captured image obtained by capturing a subject image; and
a control unit configured to control an operation of the image processing module.

2. The medical image processing device according to claim 1, wherein the image processing module is a programmable logic device.

3. The medical image processing device according to claim 2, wherein the nonvolatile memory is configured to store the image processing parameter and configuration data for the image processing module.

4. The medical image processing device according to claim 1, wherein a set of the nonvolatile memory and the image processing module are provided in plurality.

5. The medical image processing device according to claim 1, wherein
the nonvolatile memory is configured to store a plurality of types of the image processing parameters corresponding to a plurality of types of operation modes in the medical image processing device, and
the image processing module is configured to
read out the image processing parameter corresponding to the operation mode of the medical image processing device from the nonvolatile memory, and
execute image processing on the captured image using the image processing parameter.

6. The medical image processing device according to claim 1, wherein
the nonvolatile memory is configured to store a plurality of types of the image processing parameters corresponding to a plurality of types of medical observation devices, each of the medical observation devices being co figured to capture a subject image and generate the captured image, and
the image processing module is configured to
read out the image processing parameter corresponding to the medical observation device connected to the medical image processing device from the nonvolatile memory, and
execute image processing on the captured image using the image processing parameter.

7. The medical image processing device according to claim 1, wherein the image processing module is configured to spontaneously read out the image processing parameter from the nonvolatile memory after power is turned on.

8. A medical observation system comprising:
a medical observation device configured to capture a subject image to generate a captured image; and
a medical image processing device configured to execute image processing on the captured image,
wherein the medical image processing device includes:
a nonvolatile memory configured to store an image processing parameter;
an image processing module configured to
read out the image processing parameter from the nonvolatile memory, and
execute image processing on the captured image by using the image processing parameter; and
a control unit configured to control an operation of the image processing module.
